(19) United States
(12) Patent Application Publication
(10) Pub. No.: US 2010/0036741 A1
(43) Pub. Date: Feb. 11, 2010

(54) APPLICATION CURRENCY CODE FOR DYNAMIC CURRENCY CONVERSION TRANSACTIONS WITH CONTACTLESS CONSUMER TRANSACTION PAYMENT DEVICE

(76) Inventor: Marc Cleven, Half Moon Bay, CA (US)

Correspondence Address: Quarles & Brady LLP, TWO NORTH CENTRAL AVENUE, One Renaissance Square, PHOENIX, AZ, 85004-2391, US

(21) Appl. No.: 12/534,809

(22) Filed: Aug. 3, 2009

Related U.S. Application Data
(60) Provisional application No. 61/086,109, filed on Aug. 4, 2008.

(51) Int. Cl. G06Q 40/00; G06Q 20/00; G06Q 30/00; H04B 5/00

(52) U.S. Cl. 705/17; 705/44; 705/41; 455/41.1

(57) ABSTRACT

Data is wirelessly reading from a consumer's smart card and then parsed to derive the consumer's account upon which a transaction is to be conducted between a merchant and an Application Currency Code (ACC) corresponding to a second currency. The amount of the transaction is converted from the merchant's local currency to the second currency and included in an authorization request sent to the merchant's acquirer. A receipt for the amount of the transaction in the second currency is rendered if the transaction is authorized.

### CROSS NOTING

This application claims priority to U.S. Provisional Application Ser. No. 61/086,109, filed on Aug. 4, 2008, titled Application Currency Code For Dynamic Currency Conversion Transactions With Contactless Consumer Transaction Payment Device, which is incorporated herein by reference.

### BACKGROUND

Consumer portable transaction payment devices (e.g., credit cards, debit cards, charge cards and various other types of cards) are used by consumers to make purchases or to obtain cash. These transactions generally take place at a merchant's premises using an electronic Point of Service terminal (POS), and during the transaction the POS communicates with other parties to obtain authorization for the transaction, and to initiate the transfer of funds from the customer to the merchant. Similar transactions take place using computer equipment without the intermediary of a merchant.

With increasing international travel, globalization of business and electronic commerce, cardholders sometimes wish to conduct transactions in a foreign country using their card. In this case the merchant would normally use a particular currency, which, in the case of a retailer, would generally be the local currency. The credit card would also have a currency, which would generally be the local currency of its issuing bank. Conventionally, for transactions where the two currencies are different, the currency of the transaction would be the currency of the merchant, and would appear as such, together with an exchange rate on the credit card statement. Dynamic currency conversion (DCC) allows a transaction of this kind to be conducted in the currency of the card, by detecting the card currency and applying a currency conversion at the time of the transaction, so that the cardholder sees the value of the transaction in the currency of the card, at that time. For example, a POS device reads data encoded in a magstripe of a consumer's credit card. The data being read would include an identifier of an account issued by an issuer to an account holder number. From the identifier there would be extracted the Bank Identification Number (BIN) of the account. The POS, or as peripheral device in communication with the PS, associate the BIN with a currency, take this to be the currency of the card and conduct the sale/purchase in the card currency.

A standards body know as EMVCo manages, maintains and enhances the EMV® Integrated Circuit Card Specifications for chip-based payment cards and acceptance devices, including point of sale (POS) terminals and ATMs. EMVCo also establishes and administers testing and approval processes to evaluate compliance with the EMV Specifications. EMV® is a global standard for credit and debit payment cards based on chip card technology. As of Q1 2008, there were more than 730 million EMV compliant chip-based payment cards in use worldwide. EMVCo manages, maintains and enhances the EMV® Integrated Circuit Card Specifications for chip-based payment cards and acceptance devices, including point of sale (POS) terminals and ATMs. EMVCo also establishes and administers testing and approval processes to evaluate compliance with the EMV Specifications. A primary goal of EMVCo and the EMV Specifications is to help facilitate global interoperability and compatibility of chip-based payment cards and acceptance devices. This objective extends to new types of payment devices as well, including contactless payment and mobile payment.

EMVCo has a standard addressing a transactional currency translation function for chip-based payment cards (e.g., portable consumer transaction devices such as credit cards, debit cards, prepaid cards, etc.) A portion of that standard is set forth in EMV Integrated Circuit Card Specifications For Payment Systems, Book 3, Application Specification, Version 4.1, May 2004, which is incorporated herein by reference.

The portable consumer transaction device has encoded therein data that includes an Application Currency Code (ACC). The portable consumer transaction device can be used in a transaction on an account issued to an account holder by an issuer. The transaction is conducted on the account between the account holder and a merchant. The account is presented by the consumer to the merchant. The merchant, in order to conduct the transaction, has a Point of Service terminal (POS) that reads the encoded data from the portable consumer transaction device. The data being read includes the ACC. Typically, the data is read from a magnetic strip or from the contacts of a chip of a ‘smart card’. This EMV standard for the use of the ACC, however, does not address use of the ACC in any contactless payment transactional mode.

### SUMMARY

In one implementation, the invention provides a contactless payment card, and method of use, involving a wireless interrogation of the contactless payment card by a merchant. The merchant wirelessly retrieves an Application Currency Code (ACC) and an account from the card. The data read from the card can be read into a predetermined format. The ACC can then be used by the merchant to retrieve a currency conversation rate, plus any applicable extra currency-related charged, to conduct a transaction on the account in a currency preferred by the account holder as opposed to the local currency of the merchant. The merchant can offer the consumer the option to pay either in the local currency or in the currency corresponding to the ACC. A receipt, which can be given to the consumer, shows funds to be withdrawn from the account for the transaction.

In another implementation, data is wirelessly reading from a consumer's smart card and then parsed to derive the consumer's account upon which a transaction is to be conducted between a merchant and an Application Currency Code (ACC) corresponding to a second currency. The amount of the transaction is converted from the merchant's local currency to the second currency and included in an authorization request sent to the merchant's acquirer. A receipt for the amount of the transaction in the second currency is rendered if the transaction is authorized.

### BRIEF DESCRIPTION OF THE DRAWINGS

FIG. 1 depicts an exemplary environment for the provision of a service by a merchant to a consumer in authorizing and remunerating electronic payment by the consumer use of a Contactless Consumer Portable Transaction Payment Device (CCPTPD) in conducting a financial transaction with the merchant (i.e.; a credit card transaction) within an exemplary payment processing system.

FIG. 2 is a flow chart of an exemplary process, which can be practiced in the environment of FIG. 1, in which a Dynamic Currency Conversion (DCC) can be offered to conduct a contactless payment at Point-of-Sale terminals (POS) and/or Automatic Teller Machines (ATM).

FIG. 3 is a block level diagram that depicts an exemplary payment system.

FIG. 4 illustrates exemplary implementations of a CCPTPD.

FIG. 5 illustrates systems housed within an interchange center to provide online and offline transaction processing; and

FIG. 6 illustrates another view of the components of FIG. 4.

Implementations will become more apparent from the detailed description set forth below when taken in conjunction with the drawings, in which like elements bear like reference numerals.

### DESCRIPTION

Implementations of this invention facilitate a contactless payment at a Point of Service terminal (POS) environment between a merchant and a consumer who presents a Contactless Consumer Portable Transaction Payment Device (CCPTPD) (e.g., Mastercard (PayPass), Visa Inc. (PayWave), etc.) CCPTPD have passive contactless transponders that can be used for the contactless payment transactions. In addition, contactless payment has been implemented by integrating near field communications (NFC) into mobile communication devices or by using a Bluetooth proprietary feature of the mobile communication devices. The contactless payment systems have been used with various communication standards. NFC is an open standard communication system that was designed by Philips and Sony Corporation, and enhanced by the NFC forum. NFC uses Radio Frequency Identification (RFID) based technology and must comply with various standards and operating protocol/frequency for RFID.

Implementations enable the financial transaction between the merchant and the consumer to be conducted in any currency is local to the Point of Service terminal (POS) of the merchant, even though the consumer may have been issued an account corresponding to the CCPTPD by an issuer at a location that has a different currency from that of the local POS. Enabled implementations include at least the local POS currencies, issuer currencies, and/or consumer preferred currencies shown in the Currency Table in Appendix A.

An Application Currency Code (ACC) associated with the CCPTPD allows, incident to the contactless transaction, the merchant to be so informed so as to conduct the transaction in a particular currency that corresponds to the ACC.

Although the Visa PayWave™ service uses data elements as defined by the EMV standards body, the PayWave™ contactless payment transaction need not be a standard EMV transaction but rather can use the technology disclosed herein. Accordingly, this disclosure improves upon the EMV standard so that the Application Currency Code (ACC) can be used in contactless payments, such as in a Visa contactless payment. To do so, the CCPTPD (i.e., a payment card representing an account issued by an issuer to the card holder) contains data representing the ACC. Merchants and Acquirers can take advantage of this data element to perform Dynamic Current Conversion (DCC) processing.

DCC (Dynamic Currency Conversion) is a service offered at Point-of-Sale terminals (POS) and ATMs in which cardholders may elect to have a transaction converted to their card billing currency instead of making a payment in a merchant's local currency. For contactless transaction involving a chip card, there is an opportunity to identify candidate transactions for the DCC system.

The DCC service offered at Point-of-Sale terminals (POS) and ATMs can be implemented as a cross-border assessment so as to allow identification of cross-border transaction fees that can be itemized and charged to individual entities (e.g., cardholders merchant, acquirers, issuers, etc.) in the payment network for providing currency conversion processing of their requested transactions. Further, rebates may be provided to entities (e.g., merchants or acquirers) that perform their own currency conversion for transactions before submission for processing. This arrangement of “per-use” cross-border transaction processing fees may encourage elimination or reduction of cumulative post transaction (end-of-cycle file to billing) assessments that are common in the payment-by-card industry.

The cross-border transaction handling system may be configured to perform and manage calculations of cross-border assessments and billing. The cross-border transaction handling system may perform cross-border assessment calculations, and bill members on a periodic basis (e.g., daily or weekly). The cross-border transaction handling system may, for example, create three billing events: Issuer Assessment, Acquirer Assessment, and Acquirer Credit. The latter billing event corresponds to a rebate to acquirers who do not perform their own currency conversion.

In one implement, a Dynamic Currency Conversion (DCC) can be offered at Point-of-Sale terminals (POS) and Automatic Teller Machines (ATM) in which holders of an account corresponding to a CCPTPD may elect to have a transaction amount converted to their card billing currency instead of using the local currency. In this implementation, the DCC, or a Cardholder Preferred Currency (CPC), is used in a financial transaction with a merchant in which the holder of a Contactless Consumer Portable Transaction Payment Device (CCPTPD), for instance, a wireless debit card, prepaid card, credit card, stored value card, etc., has the cost of the transaction being converted to their local currency when making a payment in a foreign currency. The DCC works by allowing foreign merchants to calculate a bill for a contactless transaction that is charged in a preferred currency of the cardholder making a purchase, rather than the local currency of the merchant. DCC occurs during a contactless transaction at the point of sale (POS), where an exchange rate is applied that has been determined by technology partners through the merchant's bank. The DCC service, in this implementation, is offered to merchants by technology providers through the merchants' banks. As the DCC service is applied at the point of sale, neither the transaction hander (i.e., Visa, Mastercard, etc.) nor the issuer of the account of the card being used sets a rate for the DCC service As such, this implementation uses the DCC as a way of transferring the foreign exchange margin that the issuer normally makes when a cardholder uses the card's account outside of the issuer's country. Accordingly, the transfer is not made by the issuer but rather by the merchant's acquirer or the merchant in the country where the transaction the account takes place. The margin, in this implementation, depends on what the Acquirer/Merchant in that country applies. This implementation provides the benefit that the cardholder will know up front, at the time of the contactless transaction, what rate is being applied and what the cardholder is to pay for the transaction in their home currency. Thus, the cardholder need not wait till receiving an account statement to find out what rate the issuer applied for the transaction.

For example, a cardholder from the United States that is traveling in Europe presents a credit card to a merchant as payment for a product/service priced in Euros. The credit card details are read wirelessly, in less than one (1) second, in a contactless payment transaction captured on the point of sale device (POS). The wirelessly read data identifies that the card is a USA issued card. The cashier asks the cardholder to pay in US dollars and the POS converts the euro amount into US dollars (based on a margined daily rate). The cardholder signs a receipt that shows the euro amount, rate of exchange and the US dollar amount. The service guarantees that this exact US dollar amount will be debited to the cardholder account, and the exact euro amount will be credited to the merchant's account, to the benefit of the merchant.

In yet another implementation, a holder of an account corresponding to a CCPTPD may elect to have a transaction amount converted to their card billing currency instead of using the local currency. Where a predetermined process identifies that the holder has a contactless payment card that is a candidate for a DCC transaction, the POS determines the billing currency, and determines that the billing currency is different from the local currency at the location of the merchant's POS. Upon election by the holder to pay in the billing currency of the account of the CCPTPD, the transaction proceeds and can be concluded by the rendering of a paper receipt detailing all charges to the account as above.

In another implementation, to determine the currency of a CCPTP, a selected part of the card number, for instance the BIN number, parsed to determine a country code. The country code can be mapped to a database to establish the appropriate currency code. For example a country code for France could be mapped to the Euro. More complicated situations could also arise, for instance where a British bank issues a card for a US dollar account.

The financial side of the transaction may be managed by the POS, or by a server belonging to a bank or issuer of the CCPTP. The POS or the server may collect particular data related to DCC transactions, and store it in a DCC statistical data packet for transmission to an entity who will process DCC-related data such as a bank or the issuer of the CCPTP or another party.

In yet another implementation, a total amount is calculated for one or more goods or services to be purchased by an account holder from a merchant in a transaction conducted on an account issued to the consumer by an issuer. The total amount is calculated in a local currency amount to arrive at a total amount in a first currency that is a local currency of the merchant. Data is wirelessly read from memory in a Contactless Consumer Portable Transaction Payment Device (CCPTPD). There is derived, at least in part from the data read from the CCPTPD, account information that includes an Application Currency Code (ACC) corresponding to a second currency and an identifier for the account upon which the transaction is to be conducted. It is then determined from the parsed data whether the account information identifies a domestic account or international account. When the account information identifies a domestic account, an authorization request message is formed so as to include the total amount in the first currency. When the account information identifies an international account, it is determining whether the second currency is supported for dynamic currency conversion. When the second currency is not supported for dynamic currency conversion, the authorization request message is formed so as to include the total amount in the first currency. When the second currency is supported for dynamic currency conversion, there is obtained a conversion factor that includes a conversion rate from the first currency to the second currency plus any additional currency conversion charges, and the conversion factor is applied to the total amount in the first currency to derive a total amount in the second currency. In order to obtain the consumer's acceptance of the second currency amount for the purchase of the transaction, there is rendered a display including the total amount in the second currency. Input can then be received (either from the consumer and/or the merchant) indicating whether the total amount in the second currency for the transaction is acceptable by the consumer. When the input indicates that the total amount in the second currency for the transaction is not acceptable by the consumer, the authorization request message is formed so as to include the total amount in the first currency. When the input indicates that the total amount in the second currency for the transaction is acceptable by the consumer, the authorization request message is formed so as to include the total amount in the second currency. After the authorization request message is formed, it is sent, for delivery to a logical address for an acquirer for the merchant, along with information sufficient to identify the account upon which the transaction is to be conducted. Thereafter, in response to the authorization request message, an authorization response is received authorizing the transaction. After receiving the authorization response authorizing the transaction, a receipt is rendered so as to include funds to be withdrawn from the account for the transaction.

In the foregoing implementation, the conversion factor can include a conversion rate from the first currency to the second currency plus any additional currency conversion charges. The conversion factor is then applied to the total amount in the first currency to derive a total amount in the second currency comprise a dynamic currency conversion process. The foregoing implementation can be implemented, either in whole or in part, by a Point of Service terminal (POS), an automated teller machine (ATM), or equipment associated with telephone or Internet sales. The wirelessly reading data in any of the forgoing implementations can be accomplished by telecommunications apparatus such as near field communication (NFC) protocol and an RFID enabled card reader, Bluetooth communications apparatus, Wi-Fi communications apparatus, infrared communications apparatus, RFID communications apparatus, and combinations of these. Also, software executed by hardware to accomplish any of the foregoing implementation can be contained on computer readable medium, where the software is encoded in a hardware storage device.

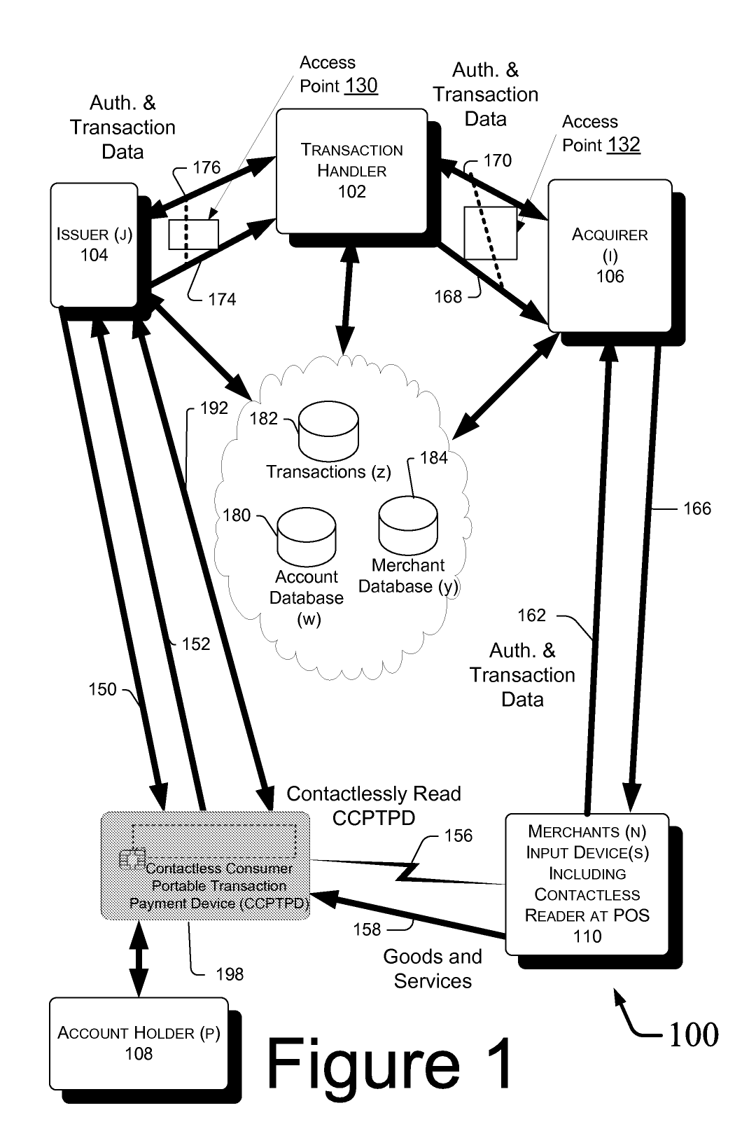

FIG. 1 depicts an exemplary process for the provision of a service by a merchant to a consumer in authorizing and remunerating electronic payment by the consumer use of a CCPTPD 198 in conducting a financial transaction with the merchant (i.e.; a credit card transaction). The diagram of FIG. 1 depicts an exemplary process 100 of a particular financial transaction system. By way of explanation for the nomenclature of reference numerals used in the Figures and described in the specification, a lower case letter in parenthesis is intended to mean an integer variable having a value from 1 to the capital case of the lower case letter, which value can be large (i.e., approaching infinity). Thus ‘(b)’ is intended to mean that the integer ‘b’ can have a value from 1 to B, and ‘(c)’ is intended to mean that the integer ‘c’ can have a value from 1 to C, etc. As such, drawing elements 104, 106, 108, 110, 180, 182, and 184 in FIG. 1 are illustrated with a block, but indicate one or more elements can be present. For example, Issuer (j) 104 is one of a possible plurality of issuers, where j may range from 1 to a large integer.

Account holder (p) 108 presents an electronic payment device (i.e.; a credit card) to a Merchant (n) 110 (wireless communications at step 156) as tender for a financial transaction such as a purchase of goods. Those of skill in the art will recognize that other financial transactions and instruments other than credit cards may also be used, including, but not limited to, a prepaid card and a debit card. For purposes of illustration and explanation, however, reference will be made to a credit card.

As part of the transaction, the Account holder's 108 CCPTPD is a contactless payment device, which can be a credit card, debit card, prepaid card, cellular telephone, Personal Digital Assistant (PDA), etc. The CCPTPD is read contactlessly by a contactless reader operated by the merchant (n) 110, whereupon account information is read from the CCPTPD and a request for authorization is transmitted to the Merchant's 110 Acquirer (i) 106 (at step 162). Each Acquirer (i) 106 is a financial organization that processes credit card transactions for businesses, for example merchants, and is licensed as a member of a transaction handler (TH) 102 such as a credit card association (i.e., Visa Inc., MasterCard, etc.) As such, each Acquirer (i) 106 establishes a financial relationship with one or more Merchants (n) 110.

The Acquirer (i) 106 transmits the account information to the TH 102 (at step 170), who in turn routes the request to the account holder's issuing bank, or Issuer (j) 104 (at step 176). The Issuer (j) 104 returns authorization information to the TH 102 (at step 174) who returns the information to the Merchant (n) 110 through the Acquirer (i) 106 (by steps 168 and 166). The Merchant (n) 110 now knowing whether the Issuer's (j) 104 credit card account is valid and supports a sufficient credit balance, may complete the transaction and the Account holder (p) 108 in turn receives goods and/or services in exchange (at step 158). Most credit card associations instruct merchants that, after receiving authorization, the detailed credit card account information obtained from the point of sale magnetic stripe scanner must be deleted.

To reconcile the financial transactions and provide for remuneration, information about the transaction is provided by the Merchant (n) 110 to Acquirer (i) 106 (at step 162), who in turn routes the transaction data to the TH 102 (at step 170) who then provides the transaction data to the appropriate Issuer (j) 104 (at step 176). The Issuer (j) 104 then provides funding for the transaction to the TH 102 (at step 174) through a settlement bank (not shown). The funds are then forwarded to the Merchant's (n) 110 Acquirer (i) 106 (at step 168) who in turn pays the Merchant (n) 110 for the transaction conducted at step 162 less a merchant discount, if applicable. The Issuer (j) 104, then bills the Account holder (p) 108 (at step 150), and the Account holder (p) 108 pays the Issuer 104 (at step 152), with possible interest or fees.

Each of the Issuer (j) 104, Merchants (n) 110, Acquirer (i) 106 and the TH 102 may have access to information resources having one or more of the following databases: transaction database (z) 182, merchant database (y) 184, or account database (w) 180. These databases can be connected by a network, internet, virtual private network, or by other means known to those skilled in the art. Moreover, not every participant must necessarily have access to any or all of the databases. Each database can assign read, write, and query permissions as appropriate to the various participants. For example, a Merchant (n) 110 have read access to the account database (w) 180 and the Issuer (j) may have read and write access.

The transaction database (z) 182 is designed to store some or all of the transaction data originating at the Merchants (n) 110 that use a payment device for each transaction conducted between an Account holder (p) 108 and the Merchant (n) 110. The transaction data can include information associated with the account of an Account holder (p) 108, date, time, and location among other more specific information including the amount of the transaction. The database can be searched using account information, date and time (or within proximity thereof), or by any other field stored in the database.

The Merchant database (y) 184 is designed to store information about each Merchant (n) 110. The Merchant database (y) can contain information such as the unique identification of each Merchant (n) 110, an identifier for each point of sale device in use by the Merchant (n) 110, and location of the Merchant (n) 110.

The account database (w) 180 is designed to store account information for payment devices associated with Account holder (p). The account database (w) 180 can store part or all of an account number, unique encryption key, account information, account name. The information from the account database (w) 180 can be associated with information from the transaction database (z) 182.

An Account holder (p) 108 initiates a transaction with a Merchant (n) 110 by presenting a CCPTPD at step 156 to the Merchant (n) 110. The card is typically presented at the Point Of Service terminal (POS) at which data thereon in read contactlessly by a radio wave reader. Certain transaction information is transmitted from the POS in route to the Merchant's (n) 110 Acquirer (i) 106 and only some of the information may contain sensitive information. The transaction information can include account information, account name, transaction balance, transaction time, transaction date, and transaction location. Sensitive information includes information such account number and account holder name that identify and associate a particular account with a particular account holder. This transaction information may be transmitted via a less secure communication medium. In addition, a transmission of transaction data may occur with weak or no encryption between two or more points from the point of origin, such as the point of sale device at the Merchant (n) 110, and the ultimate destination, such as the Acquirer (i) 106. These points can include, without limitation, from the CCPTPD reader to the POS, the POS at the Merchant (n) 110 and a network router or computer that is connected to a network but is housed and maintained by the Merchant (n) 110 and between the Merchant (n) 110 and the Acquirer (i) 106. The communication channel could be Ethernet, wireless internet, satellite, infrared transmission, or other known communication protocols. Some or all of the transmission may also be stored for record keeping, archival or data mining purposes with little or no encryption. For example, the Merchant (n) 110 may store transaction data, including certain account information in the Merchant's (n) 110 accounts on file database for reuse later.

Furthermore, many POS systems include a certain amount of transaction validation. Transaction validation is used to detect common errors, inconsistencies, and other transaction related problems before communicating with the Acquirer (i) 106. Such transaction validation can include confirming the payment type, routing information, certain aspects of the account number (like length and unique identifiers). These validation routines rely upon specific formatting criteria such as the fact that a valid account number is of a given length comprised of numbers zero through nine. Any deviation from these rules may cause the system to preemptively terminate a transaction and request the Account holder (p) 108 retry their payment device. In such situations, encrypting some or all of the transaction data using standard encryption techniques would cause the transaction validation tests to fail. For example, using standard encryption techniques on an account number will change the character type, may change the length, may alter required values (such as affecting numbers indicating card type or routing information).

In this process, transaction information is retrieved from the POS at a Merchant (n) 106. The transaction information is comprised of account information together with other information about the transaction itself: time, date, location, value, etc. Certain of the transaction information is considered sensitive information including, without limitation, account number, credit card verification number, and account name.

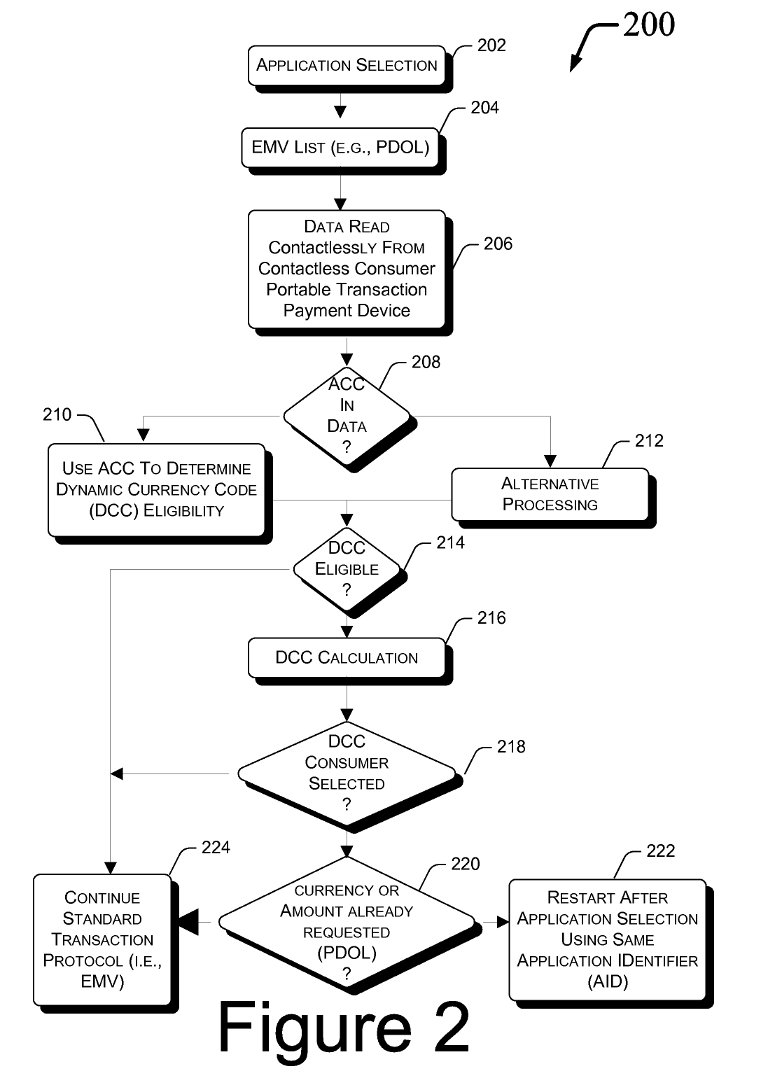

Referring now to method 200 in FIG. 2, an identification of a CCPTPD is made as to whether it is a candidate for a DCC transaction, and if so, then a transaction flow is illustrated where DCC is processed. A determination is made as to the billing currency, and a determination is made as to whether the billing currency is different from the local currency at the location of the merchant's POS. ATMs and Merchant POS devices that support EMV processing can request the Application Currency Code (ACC) from a CCPTPD that is complaint with EMV standards and can use the ACC to initiate DCC candidacy processing. A POS may locally identify candidate transactions by reading the ACC from the CCPTPD during a contactless interrogation thereof incident to conducting a transaction. A comparison can then be made between the ACC and the currency of the transaction. Alternatively, the ACC can be compared to a list of currencies where Dynamic Current Conversion (DCC) is supported (e.g., see the table of currencies in Appendix A.) Where the currency of the CCPTPD is the same as the transaction currency, or not supported by the DCC process, the transaction may proceed using the local transaction currency and no reference to DCC need be made.

For DCC candidate transactions, or for CCPTPD where the ACC is not present, the transaction can use the standard EMV functions to obtain the Primary Account Number (PAN). The POS may also have to apply a currency conversation factor to the floor limit used to determine when online authorization is desirable for the CCPTPD. The EMV process can use be to convert the currency and the amount and these can be displayed to the cardholders He transaction currency code and the mount can be part of a generated cryptogram and can be included in the authorization/clearing along with all cryptogram fields.

At steps 202 through 206 in method 200 of FIG. 2, an EMV transaction is initiated and if the Integrated Circuit Card (ICC) of the CCPTPD requires terminal resident data to initiate the financial transaction, it will communicate a list of data elements using an EMV-specified data element list (e.g., the EMV Processing Options Data Object List (PDOL)). Step 206 illustrates a step in which wireless communication of data from a CCPTPD to an interrogating card reader occurs, where the card reader is in communication with the POS.

At step 208, if the Application Currency Code (EMV Tag ‘9F42’) is found in the data read contactlessly from the CCPTPD, method 200 moves to step 210 at which the POS may determine if the transaction is DCC eligible at step 214 and, if so, then method 200 proceeds to step 216 at which a calculation is made as to the DCC offer. If the transaction is not DCC eligible, the method 200 moves to step 212 at which the POS may continue with the current EMV transaction. Also at step 221, if the Application Currency Code (EMV Tag ‘9F42’) has not read in the data contactlessly from the CCPTPD, then the POS may use alternate means to determine if the transaction is DCC eligible. For instance, the Primary Account Number (PAN) can be used by an application to determine DCC eligibility.

At step 216 where a calculation is made as to the DCC offer, if the transaction is eligible for DCC, however identified, the transaction will use the same means to obtain a currency conversion rate as is the case for standard non-smart card (i.e., non-chip) logic. The holder of the CCPTPD should then be offered the DCC option according to payment system rules.

At step 218, a query is made as to whether the DCC option is not elected by the holder of the CCPTPD. If not elected, then the method 200 moves to step 224 at which the current EMV transaction can continue in the local currency. Otherwise, method 200 moves to step 220 at which the POS checks whether the amount of the financial transaction, an Authorized Code (EMV Tag ‘9F02’) and/or a Transaction Currency Code (EMV Tag ‘5F2A’), were requested in the EMV's list (e.g. the PDOL). If the amount and/or the transaction currency were not requested in the EMV's list, method 200 moves to step 224 where the POS should continue with the amount and currency adjusted according to the DCC selection. If the amount and/or the transaction currency were requested in the EMV's list, method 200 moves to step 222 at which the current EMV transaction should be terminated and the transaction restarted, using the same Application Identifier (AID), with the amount and currency adjusted according to the DCC selection, preferably without intervention by the holder of the CCPTPD. The restarted EMV application should follow the normal EMV transaction flow and need not involve any further DCC activity.

Method 200 is suitable for alternative implementations that allow DCC to be performed only to as to not involve the cardholder or the merchant until after it has been determined whether DCC is available, what the currency conversion rate is, or whether any other status conditions exist that would prohibit the DCC from transaction from being completed. In this manner, DCC transactions can be controlled, the number of improper transactions can be minimized, and cardholders and merchants are not involved with processes until after it is determined that DCC can occur. As such, such implementations of method 200 can prevent DCC from being initiated when not allowed because of the issuing bank is not a participating bank, where a multicurrency processor is unavailable for processing DCC transactions, where the point of sale terminal or merchant is temporarily suspended from processing eligible direct currency transactions, or in other suitable situations. Thus, situations are minimized where a cardholder is erroneously presented with the option of a DCC transaction, or where a cardholder provides incorrect data regarding the types of currency that are available for DCC transactions, thus avoiding unnecessary processing of such incorrect data.

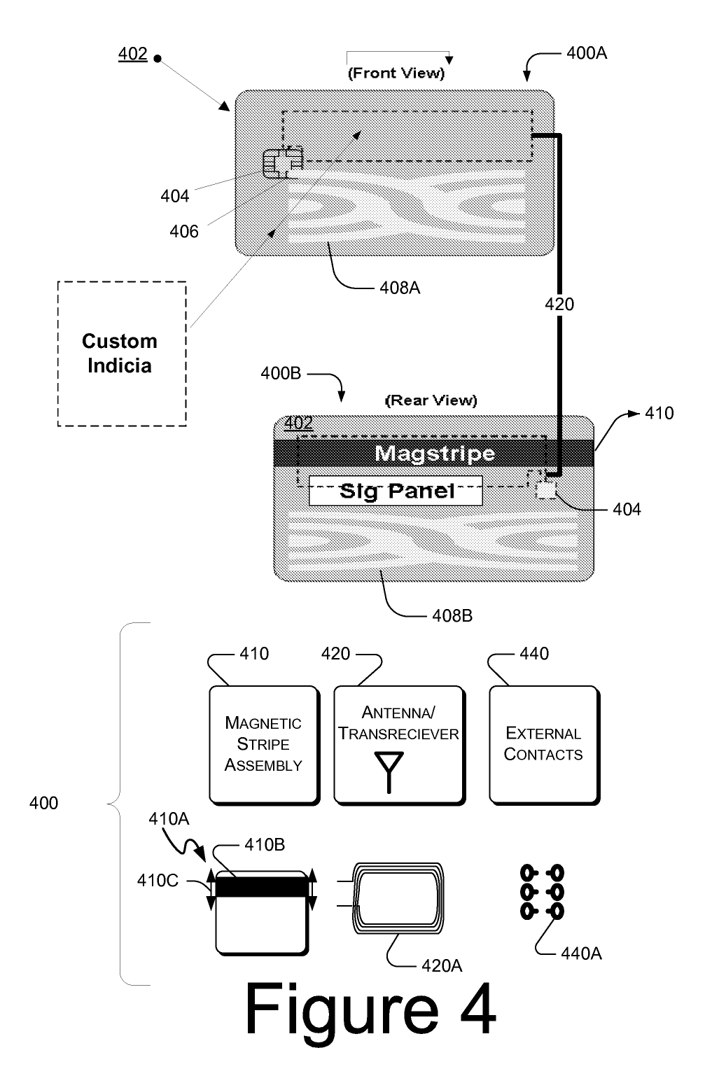

FIG. 4 illustrates an exemplary implementation of a CCPTPD as described above, and shows front and rear views (400A, 400B). Images may be displayed on both sides of the CCPTPD 402, with an image 408A on the front view 400A being either the same as or different from an image 408B on the rear view 400B. In this illustration, the front view 400A can also display custom indicia.

FIG. 4 also shows exemplary implementations of a data encoding area of the CCPTPD 402. The data encoding area may include an optional shielding element, which allows desired electromagnetic, optical, or radiative signals to penetrate while protecting the data encoding area from physical abuse or damage. The CCPTPD 402 may optionally have areas outside of the data encoding area shielded from physical abuse or otherwise acceptable forms of electromagnetic radiation. Some of the acceptable signals that are allowed to penetrate the shielding and may include, but are not limited to, signals accompanying a magnetic field, RFID signals, IrDA signals, visible light, invisible light, modulated laser, and/or modulated RF communication signals. By way of example and not by way of limitation, a selective shielding element may comprise a clear plastic shield, conformal coatings, an opaque plastic shield, or a clear thin film, depending on the implementation of the data encoding area.

Non-limiting examples of the data encoding area are shown at reference numeral 400, and include an antenna and/or transceiver 420 for conduct financial transactions contactlessly. Also in FIG. 4 is an exemplary implementation of the data encoding area shown as an antenna and/or transceiver 420. The antenna 420 may include commonly used loop inductors such as the one shown 420A or in those shown in related ISO standards for RF-readable smart cards. With such an interface, account data may be translated, modulated and transmitted in a manner acceptable by an RF contactless merchant POS terminal, a 802.11 Wi-Fi or WiMax network, or by a cellular or RF communications network.

Optionally, CCPRPD 402 may also include a magnetic stripe assembly 410 and electrical contacts 440, The magnetic stripe assembly 410 may comprise, in one implementation 410A, a reprogrammable magnetic stripe 410B that accepts data and/or commands from a processor and formats and renders that data into a form on a magnetic stripe that is readable by conventional merchant magnetic stripe-reading point of sale (POS) terminals. In this manner, the processor may program a particular account for use in a transaction as a function of user input selecting the account. Alternatively, the processor may erase the magnetic stripe of the assembly 410, rendering the card useless in the event of its loss or theft. In one implementation shown 410A, the magnetic stripe assembly 410B at least partially slidably moves 410C into and out of an assembly of the CCPTPD 402 (partial view shown), allowing the CCPTPD 402 to conduct a financial transaction at a point of sale terminal that includes a magnetic stripe reader.

External contacts 440 are yet another alternative implementation of the data encoding area shown in FIG. 4. With the CCPTPD 402 possessing physical contacts such as an array of conductive pads or shapes 240A, the CCPTPD may be placed in physical contact with a merchant's POS, and the external contacts 440 may establish connectivity to the merchant's financial processing system. The processor may relay account-related information to the merchant POS terminal through the contact interface, thereby allowing the CCPTPD 402 to be utilized with the large number of preexisting merchant POS terminals.

Payment Processing System

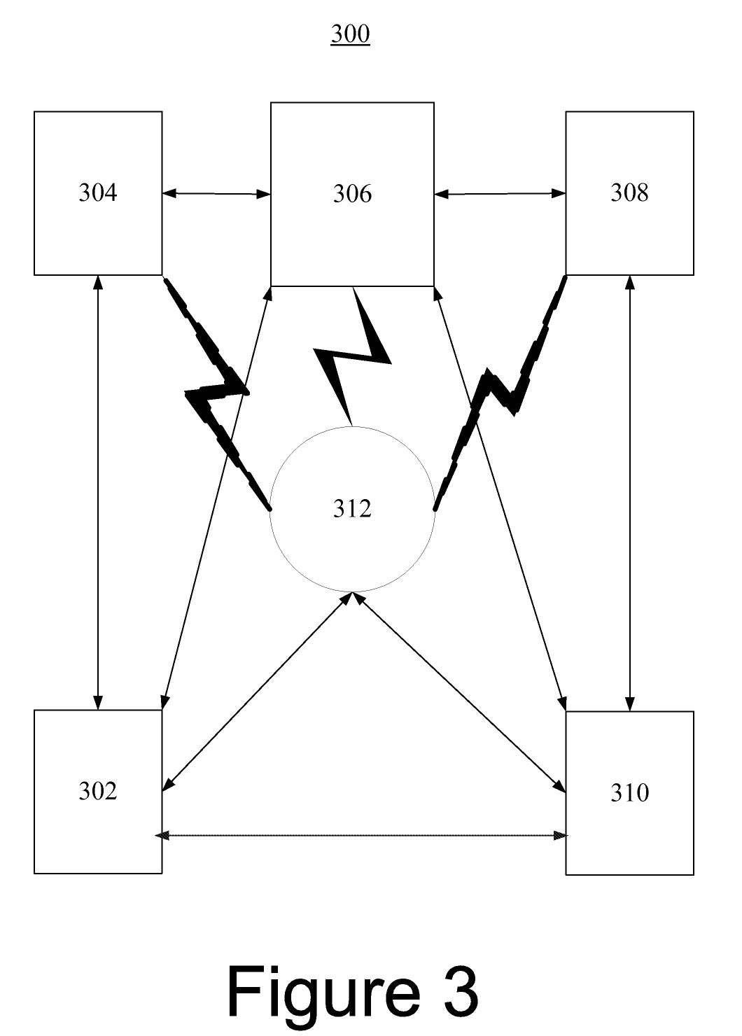

The Payment System illustrated in FIG. 3 depicts an exemplary process which can be used by the foregoing Implementations with respective modifications as described therein.

A transaction includes participation from different entities that are a component of a payment processing system 300 including an issuer 302, a transaction handler 304, such as a credit card company, an acquirer 306, a merchant 308, or a user 310 such as an account holder and/or consumer. The acquirer 306 and the issuer 302 can communicate through the transaction handler 304. Merchant 308 will be a person or entity that sells goods or services, and will more preferably be one or more transit systems as described in the above implementations. Merchant 308 include, for instance, a bus company, a subway system, a light rail system, a private or municipal transit system, and the like. Merchant 308 may utilize at least one Point-of-Service (POS) terminal that can communicate with the acquirer 306, the transaction handler 304, or the issuer 302. Thus, the POS terminal is in operative communication with the payment processing system 300. The POS terminal may be at a turnstile of a subway entry or exit point, on a commuter train or terminal thereof, on a light rail train or terminal thereof, on a city bus or terminal thereof, on a water taxi or terminal thereof, and the like.

Typically, a transaction begins with the user 310, such as an account holder or a consumer, presenting a Contactless Consumer Portable Transaction Payment Device (CCPTPD) 312 to merchant 308 to initiate an exchange for a good or service. The CCPTPD 312 will preferably be a contactless bank card as described in the above implementations. The CCPTPD 312 may include a volatile or non-volatile memory to store information such as the account number or an account holder's name.

Merchant 308 may use the POS terminal to obtain account information, such as an account number, from the portable consumer device. The CCPTPD 312 may interface with the POS terminal using a mechanism that will include a contactless system using a radio frequency and/or magnetic field recognition system, but may additionally be adapted for use in a contact system such as by a magnetic stripe reader. The POS terminal sends a transaction authorization request to the issuer 302 of the portable consumer device. Alternatively, or in combination, the CCPTPD 312 may communicate with the issuer 302, the transaction handler 304, or the acquirer 306.

The issuer 302 may authorize the transaction using the transaction handler 304. The transaction handler 304 may also clear the transaction. Authorization includes the issuer 302, or the transaction handler 304 on behalf of the issuer 302, authorizing the transaction in connection with the issuer's 302 instructions such as through the use of business rules. The business rules could include instructions or guidelines from the transaction handler 304, the user 310, merchant 308, the acquirer 306, the issuer 302, a financial institution, or combinations thereof. The transaction handler 304 may maintain a log or history of authorized transactions. Once approved, merchant 308 will record the authorization, allowing the user 310 to receive the good or service.

Merchant 308 may, at discrete periods, such as the end of the day, submit a list of authorized transactions to the acquirer 306 or other components of the payment processing system 300. The transaction handler 304 may compare the submitted authorized transaction list with its own log of authorized transactions. If a match is found, the transaction handler 304 may route authorization transaction amount requests from the corresponding acquirer 306 to the corresponding issuer 302 involved in each transaction. Once the acquirer 306 receives the payment of the authorized transaction amount from the issuer 302, it can forward the payment to merchant 308 less any transaction costs, such as fees. If the transaction involves a debit or pre-paid card, the acquirer 306 may choose not to wait for the initial payment prior to paying the merchant 308.

There may be intermittent steps in the foregoing process, some of which may occur simultaneously. For example, the acquirer 306 can initiate the clearing and settling process, which can result in payment to the acquirer 306 for the amount of the transaction. The acquirer 306 may request from the transaction handler 304 that the transaction be cleared and settled. Clearing includes the exchange of financial information between the issuer 302 and the acquirer 306 and settlement includes the exchange of funds. The transaction handler 304 can provide services in connection with settlement of the transaction. The settlement of a transaction includes depositing an amount of the transaction settlement from a settlement house, such as a settlement bank, which the transaction handler 304 typically chooses, into a clearinghouse, such as a clearing bank, that the acquirer 306 typically chooses. The issuer 302 deposits the same from a clearinghouse, such as a clearing bank, which the issuer 302 typically chooses into the settlement house. Thus, a typical transaction involves various entities to request, authorize, and fulfill processing the transaction.

In FIGS. 1 and 3 illustrates exemplary telecommunications networks that each may make use of any suitable telecommunications network and may involve different hardware, different software and/or different protocols then those discussed below. These global telecommunications networks supports purchase and cash transactions using any bankcard, travel and entertainment cards, and other private label and proprietary cards. The network also supports ATM transactions for other networks, transactions using paper checks, transactions using smart cards and transactions using other financial instruments.

These transactions are processed through the network's authorization, clearing and settlement services. Authorization is when an issuer approves or declines a sales transaction before a purchase is finalized or cash is dispersed. Clearing is when a transaction is delivered from an acquirer to an issuer for posting to the customer's account. Settlement is the process of calculating and determining the net financial position of each member for all transactions that are cleared. The actual exchange of funds is a separate process.

Transactions can be authorized, cleared and settled as either a dual message or a single message transaction. A dual message transaction is sent twice—the first time with only information needed for an authorization decision, an again later with additional information for clearing and settlement. A single message transaction is sent once for authorization and contains clearing and settlement information as well. Typically, authorization, clearing and settlement all occur on-line.

FIGS. 1 and 3 include one or more transaction handlers 102, 304, access points 130, 132, acquirers 106/306, and issuers 104/302. Other entities such as drawee banks and third party authorizing agents may also connect to the network through an access point. An interchange center is a data processing center that may be located anywhere in the world. In one embodiment, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferable, the communication lines that connect an interchange center (transaction handlers 102, 304) to remote entities use dedicated high-bandwidth telephone circuits or satellite connections based on the IBM SNA-LU0 communication protocol. Messages are sent over these lines using any suitable implementation of the ISO 8583 standard.

Access points 130, 132 are typically made up of small computer systems located at a processing center that interfaces between the center's host computer and the interchange center The access point facilitates the transmission of messages and files between the host and the interchange center supporting the authorization, clearing and settlement of transaction. Telecommunication links between the acquirer (q) and its access point, and between the access point and issuer (i) 104 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

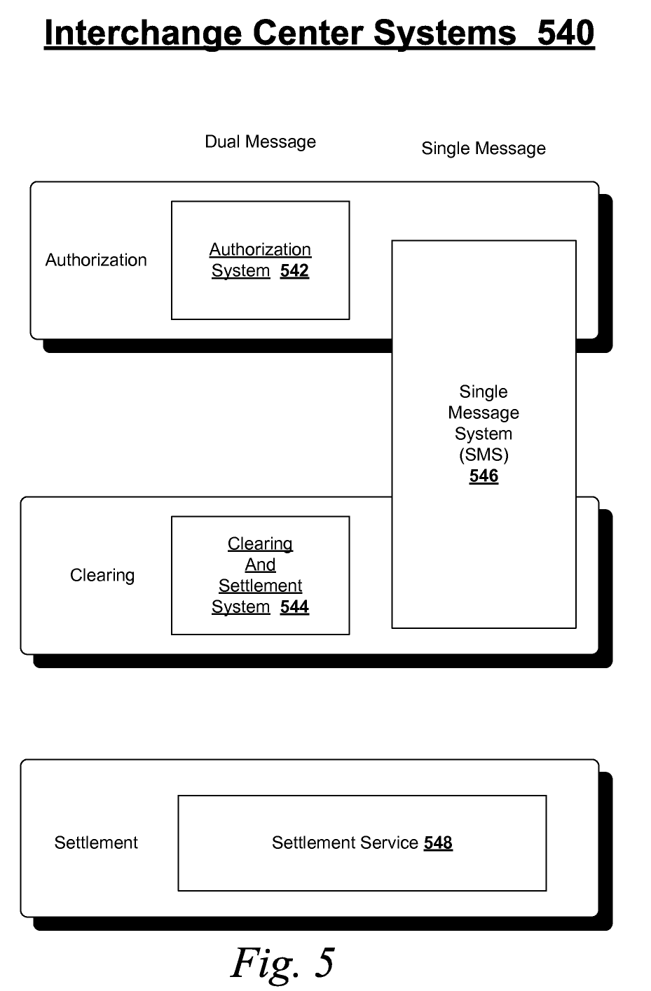

FIG. 5 illustrates systems 540 housed within an interchange center to provide on-line and off-line transaction processing. For dual message transaction, authorization system 542 provides authorization. System 542 supports on-line and off-line functions, and its file includes internal systems tables, a customer database and a merchant central file. The on-line functions of system 542 support dual message authorization processing. This processing involves routing, cardholder and card verification and stand-in processing, and other functions such as file maintenance. Off-line functions including reporting, billing, and generating recovery bulletins. Reporting includes authorization reports, exception file and advice file reports, POS reports and billing reports. A bridge from system 542 to system 546 makes it possible for members using system 542 to communicate with members using system 546 and access the SMS gateways to outside networks.

Clearing and settlement system 544 clears and settles previously authorized dual message transactions. Operating six days a week on a global basis, system 544 collects financial and non-financial information and distributes reports between members It also calculates fees, charges and settlement totals and produces reports to help with reconciliation. A bridge forms an interchange between system 544 processing centers and system 546 processing centers.

Single message system 546 processes full financial transactions. System 546 can also process dual message authorization and clearing transactions, and communicates with system 542 using a bridge and accesses outside networks as required. System 546 processes Visa, Plus Interlink and other card transactions. The SMS files comprise internal system tables that control system access and processing, and the cardholder database, which contains files of cardholder data used for PIN verification and stand-in processing authorization. System 546 on-line functions perform real-time cardholder transaction processing and exception processing for authorization as well as full financial transactions. System 546 also accumulates reconciliation and settlement totals. System 546 off-line functions process settlement and funds transfer requests and provide settlement and activities reporting. Settlement service 548 consolidates the settlement functions of system 544 and 546, including Interlink, into a single service for all products and services. Clearing continues to be performed separately by system 544 and system 546.

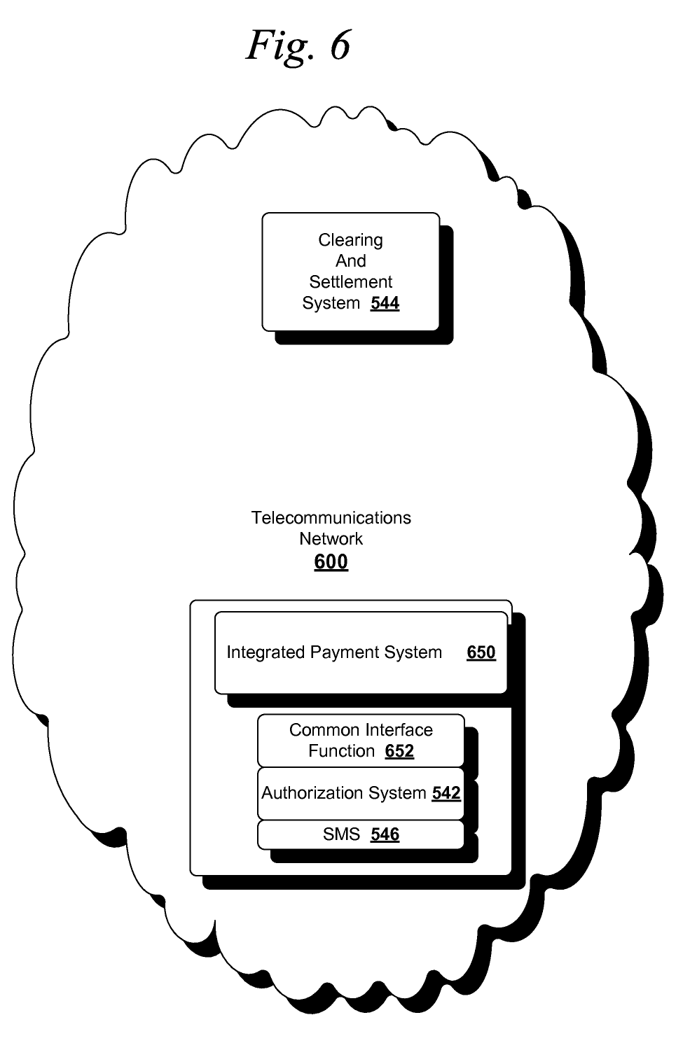

FIG. 6 illustrates another view of components of FIGS. 1 and 3 as a telecommunications network 900. Integrated payment system 650 is the primary system for processing all on-line authorization and financial request transactions. System 650 reports both dual message and single message processing. In both cases, settlement occurs separately. The three main software components are the common interface function 652, authorization system 542 and single message system 546.

Common interface function 652 determines the processing required for each message received at an interchange center. It chooses the appropriate routing, based on the source of the message (system 542, 544 or 546), the type of processing request and the processing network. This component performs initial message editing, and, when necessary, parses the message and ensures that the content complies with basic message construction rules. Common interface function 652 routes messages to their system 542 or system 546 destinations.

Various terms may be used herein, which are to be understood according to the following descriptions 1 through 8.

1. Acceptance point device includes a device capable of communicating with a payment device, where the acceptance point device can include a Point of Device (POS) device, a smartcard, a payment card such as a credit or debit card with a magnetic strip and without a microprocessor, a keychain device such as the SPEEDPASS® commercially available from ExxonMobil® Corporation, a cellular phone, personal digital assistant (PDA), a pager, a security card, an access card, a smart media, a transponder, personal computer (PC), tablet PC, handheld specialized reader, set-top box, electronic cash register (ECR), automated teller machine (ATM), virtual cash register (VCR), kiosk, security system, or access system.

2. Account holder or user includes any person or entity with an account and/or a payment device associated with an account, where the account is within a payment system.

3. Issuer includes any entity that issues one or more accounts and/or payment devices.

4. Merchant includes any entity that supports an acceptance point device.

5. Participant includes any user, person, entity, charitable organization, machine, hardware, software, merchant or business who accesses and uses the system of the invention, such as any consumer (such as primary member and supplementary member of an aggregate consumer account), retailer, manufacturer, and third-party provider, and any subset, group or combination thereof.

6. Redemption includes obtaining a reward using any portion of points, coupons, cash, foreign currency, gift, negotiable instruments, or securities;

7. Reward includes any discount, credit, good, service, package, event, experience (such as wine tasting, dining, travel), or any other item.

8. Payment device includes a card, smartcard, ordinary credit or debit cards (with a magnetic strip and without a microprocessor), a keychain device (such as the SPEEDPASS™ service commercially available from Exxon-Mobil Corporation), cellular phone, personal digital assistant (PDA), pager, payment card, security card, access card, smart media, or transponder, where each payment device can include a loyalty module with a computer chip with dedicated hardware, software, embedded software, or any combination thereof that is used to perform actions associated with a loyalty program.

The steps of a method, process, or algorithm described in connection with the implementations disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed implementations is provided to enable any person of ordinary skill in the art to make or use the disclosure. Various modifications to these implementations will be readily apparent to those of ordinary skill in the art, and the generic principles defined herein may be applied to other implementations without departing from the spirit or scope of the disclosure. Thus, the disclosure is not intended to be limited to the implementations shown herein but is to be accorded the widest scope consistent with the principles and novel features disclosed herein.

### APPENDIX ‘A’

### Currency Table

| Country and | Currency | Graphic |
|---|---|---|
| Currency | Code | Image |
| Albania, Leke | ALL | Lek |
| America (United | USD | $ |
| States of | | |
| America), | | |
| Dollars | | |
| Afghanistan, | AFN | [symbol] |
| Afghanis | | |
| Argentina, | ARS | $ |
| Pesos | | |
| Aruba, Guilders | AWG | f |
| (also called | | |
| Florins) | | |
| Australia, | AUD | $ |
| Dollars | | |
| Azerbaijan, New | AZN | MaH |
| Manats | | |
| Bahamas, | BSD | $ |
| Dollars | | |
| Barbados, | BBD | $ |
| Dollars | | |
| Belarus, Rubles | BYR | p. |
| Belgium, Euro | EUR | [symbol] |
| Belize, Dollars | BZD | BZ$ |
| Bermuda, | BMD | $ |
| Dollars | | |
| Bolivia, | BOB | $b |
| Bolivianos | | |
| Bosnia and | BAM | KM |
| Herzegovina, | | |
| Convertible | | |
| Marka | | |
| Botswana, | BWP | P |
| Pulas | | |

What is claimed is:

1. A method comprising a plurality of steps each being performed by hardware executing software, wherein the steps include:
for one or more goods or services to be purchased by an account holder from a merchant in a transaction conducted on an account issued to the consumer by an issuer, summing a local currency amount for each of the goods and services to arrive at a total amount in a first currency that is a local currency of the merchant;
wirelessly reading data stored in memory of a Contactless Consumer Portable Transaction Payment Device (CCPTPD);
parsing the data read from the CCPTPD, using a predetermined format corresponding to the data being read, to obtain account information that includes:
an Application Currency Code (ACC) corresponding to a second currency; and
an identifier for the account upon which the transaction is to be conducted;
determining from the parsed data whether the account information identifies a domestic account or international account;
when the account information identifies:
a domestic account, forming an authorization request message so as to include the total amount in the first currency; and
an international account:
obtaining a conversion factor that includes a conversion rate from the first currency to the second currency plus any additional currency conversion charges;
applying the conversion factor to the total amount in the first currency to derive a total amount in the second currency; and
forming the authorization request message so as to include the total amount in the second currency;
sending the authorization request message, including information sufficient to identify the account upon which the transaction is to be conducted, for delivery to a logical address for an acquirer for the merchant;
receiving, in response to the authorization request message, an authorization response authorizing the transaction; and
rendering, after receiving the authorization response authorizing the transaction, a receipt that includes funds to be withdrawn from the account for the transaction.

2. The method as defined in Clam 1, wherein the steps of obtaining a conversion factor that includes a conversion rate from the first currency to the second currency plus any additional currency conversion charges and applying the conversion factor to the total amount in the first currency to derive a total amount in the second currency comprise a dynamic currency conversion process.

3. The method as defined in Clam 1, wherein the hardware is one of:
a Point of Service terminal (POS);
an automated teller machine (ATM); and
equipment associated with telephone or Internet sales.

4. The method as defined in Clam 1, wherein wirelessly reading data comprises reading the data with telecommunications apparatus selected from the group consisting of:
a near field communication (NFC) protocol and RFID enabled card reader;
Bluetooth communications apparatus;
Wi-Fi communications apparatus;
infrared communications apparatus; RFID communications apparatus;
and combinations thereof.

5. A computer readable medium comprising the software of claim 1 encoded in a hardware storage device.

6. A method comprising a plurality of steps each being performed by hardware executing software, wherein the steps include:
for one or more goods or services to be purchased by an account holder from a merchant in a transaction conducted on an account issued to the consumer by an issuer, summing a local currency amount for each of the goods and services to arrive at a total amount in a first currency that is a local currency of the merchant;
wirelessly reading data stored in memory of a Contactless Consumer Portable Transaction Payment Device (CCPTPD);
deriving, at least in part from the data read from the CCPTPD, account information that includes:
an Application Currency Code (ACC) corresponding to a second currency; and
an identifier for the account upon which the transaction is to be conducted;
determining from the parsed data whether the account information identifies a domestic account or international account;
when the account information identifies:
a domestic account, forming an authorization request message so as to include the total amount in the first currency; and
an international account:
determining whether the second currency is supported for dynamic currency conversion;
when the second currency is not supported for dynamic currency conversion, forming the authorization request message so as to include the total amount in the first currency;
when the second currency is supported for dynamic currency conversion:
obtaining a conversion factor that includes a conversion rate from the first currency to the second currency plus any additional currency conversion charges;
applying the conversion factor to the total amount in the first currency to derive a total amount in the second currency; and
forming the authorization request message so as to include the total amount in the second currency;
sending the authorization request message, including information sufficient to identify the account upon which the transaction is to be conducted, for delivery to a logical address for an acquirer for the merchant;
receiving, in response to the authorization request message, an authorization response authorizing the transaction; and
rendering, after receiving the authorization response authorizing the transaction, a receipt that includes funds to be withdrawn from the account for the transaction.

7. The method as defined in Clam 6, wherein the steps of obtaining a conversion factor that includes a conversion rate from the first currency to the second currency plus any additional currency conversion charges and applying the conversion factor to the total amount in the first currency to derive a total amount in the second currency comprise a dynamic currency conversion process.

8. The method as defined in Clam 6, wherein the hardware is one of:
a Point of Service terminal (POS);
an automated teller machine (ATM); and
equipment associated with telephone or Internet sales.

9. The method as defined in Clam 6, wherein wirelessly reading data comprises reading the data with telecommunications apparatus selected from the group consisting of:
a near field communication (NFC) protocol and RFID enabled card reader;
Bluetooth communications apparatus;
Wi-Fi communications apparatus;
infrared communications apparatus; RFID communications apparatus;
and combinations thereof.

10. A computer readable medium comprising the software of claim 6 encoded in a hardware storage device.

11. A method comprising a plurality of steps each being performed by hardware executing software, wherein the steps include:
for one or more goods or services to be purchased by an account holder from a merchant in a transaction conducted on an account issued to the consumer by an issuer, summing a local currency amount for each of the goods and services to arrive at a total amount in a first currency that is a local currency of the merchant;
wirelessly reading data stored in memory of a Contactless Consumer Portable Transaction Payment Device (CCPTPD);
deriving, at least in part from the data read from the CCPTPD, account information that includes:
an Application Currency Code (ACC) corresponding to a second currency; and
an identifier for the account upon which the transaction is to be conducted;
determining from the parsed data whether the account information identifies a domestic account or international account;
when the account information identifies:
a domestic account, forming an authorization request message so as to include the total amount in the first currency; and
an international account:
determining whether the second currency is supported for dynamic currency conversion;
when the second currency is not supported for dynamic currency conversion, forming the authorization request message so as to include the total amount in the first currency; and
when the second currency is supported for dynamic currency conversion:
obtaining a conversion factor that includes a conversion rate from the first currency to the second currency plus any additional currency conversion charges;
applying the conversion factor to the total amount in the first currency to derive a total amount in the second currency;
rendering a display including the total amount in the second currency;
receiving input indicating whether the total amount in the second currency for the transaction is acceptable by the consumer;
when the input indicates that the total amount in the second currency for the transaction is not acceptable by the consumer, forming the authorization request message so as to include the total amount in the first currency;
when the input indicates that the total amount in the second currency for the transaction is acceptable by the consumer, forming the authorization request message so as to include the total amount in the second currency;
sending the authorization request message, including information sufficient to identify the account upon which the transaction is to be conducted, for delivery to a logical address for an acquirer for the merchant;
receiving, in response to the authorization request message, an authorization response authorizing the transaction; and
rendering, after receiving the authorization response authorizing the transaction, a receipt that includes funds to be withdrawn from the account for the transaction.

12. The method as defined in Clam 11, wherein the steps of obtaining a conversion factor that includes a conversion rate from the first currency to the second currency plus any additional currency conversion charges and applying the conversion factor to the total amount in the first currency to derive a total amount in the second currency comprise a dynamic currency conversion process.

13. The method as defined in Clam 11, wherein the hardware is one of:
a Point of Service terminal (POS);
an automated teller machine (ATM); and
equipment associated with telephone or Internet sales.

14. The method as defined in Clam 11, wherein wirelessly reading data comprises reading the data with telecommunications apparatus selected from the group consisting of:
a near field communication (NFC) protocol and RFID enabled card reader;
Bluetooth communications apparatus;
Wi-Fi communications apparatus;
infrared communications apparatus; RFID communications apparatus;
and combinations thereof.

15. A computer readable medium comprising the software of claim 11 encoded in a hardware storage device.
